(19) United States
(12) Patent Application Publication
(10) Pub. No.: US 2026/0218073 A1
(43) Pub. Date: Jul. 30, 2026

(54) METHOD AND APPARATUS FOR CLEANING GASIFICATION PRODUCT AND USE

(71) Applicant: TEKNOLOGIAN TUTKIMUSKESKUS VTT OY, Espoo (FI)

(72) Inventor: Matti Nieminen, Espoo (FI)

(21) Appl. No.: 19/141,567

(22) PCT Filed: Dec. 20, 2022
(86) PCT No.: PCT/FI2022/050853

§ 371 Date: Jun. 20, 2025

(51) Int. Cl. C10K 1/12; C10J 3/46; C10J 3/48; C10K 1/00; C10K 1/02

(52) U.S. Cl. CPC C10K 1/122; C10J 3/463; C10J 3/482; C10K 1/003; C10K 1/024; C10J 2300/0946; C10J 2300/0976; C10J 2300/1618

(57) ABSTRACT

The invention relates to a method and an apparatus for cleaning a gasification product (4) formed from plastic-based raw material (3) by means of a gasification. The plastic-based raw material (3) containing chlorine is gasified in the gasification unit comprising at least one fluidized bed gasification reactor (1) in which the gasification is performed to form the gasification product (4). A liquid sorbent composition (6) is sprayed to the gasification product (4), and the gasification product (4) is cooled. The gasification product (4) is supplied at a temperature of below 500° C. to a filter (2) in which solids (8) comprising chloride is removed from the gasification product (4). Further, the invention relates to the use of the method.

### FIELD

The application relates to a method defined in claim 1 and an apparatus defined in claim 20 for cleaning a gasification product formed from plastic-based raw material. Further, the application relates to a use of the method defined in claim 28.

### BACKGROUND

Known from the prior art is to produce products from plastic waste. PVC is typical harmful contaminant of the plastic waste. HCl is released from PVC at elevated temperature, e.g. temperatures of over 400° C. i.e. PVC decomposes easily at the elevated temperature producing HCl. HCl is very corrosive gas. Typically, downstream process operations do not tolerate HCl in the plastic waste treatment processes, e.g. in a steam cracking process. It is known that waste comprising mixed plastics is difficult to recycle and to utilize as raw material in new products.

### OBJECTIVE

The objective is to solve the above problems. Further, the objective is to clean a gasification product, and especially to remove chlorine from the product. Further, the objective is to recycle different plastic-based materials and plastics and to recover olefins from these materials.

### SUMMARY

The method and apparatus and use are characterized by what are presented in the claims.

In the method and apparatus, a gasification product formed from plastic-based raw material by means of a gasification is cleaned. The plastic-based raw material containing chlorine is gasified in the gasification unit comprising at least one fluidized bed gasification reactor to form the gasification product, a sorbent composition is sprayed to the gasification product and the gasification product is cooled, and the gasification product is supplied to a filter in which solids comprising chloride is removed from the gasification product.

### BRIEF DESCRIPTION OF THE DRAWING

The accompanying drawings, which are included to provide a further understanding of the invention and constitute a part of this specification, illustrate some embodiments of the invention and together with the description help to explain the principles of the invention. In the drawings:

FIG. 1 shows a flow chart illustration of a process and apparatus according to one embodiment, and

FIG. 2 shows a flow chart illustration of a process and apparatus according to another embodiment.

### DETAILED DESCRIPTION

In the method a gasification product is cleaned. The gasification product is formed from plastic-based raw material by means of a gasification, wherein the plastic-based raw material containing chlorine is gasified in the gasification unit comprising at least one fluidized bed gasification reactor in which the gasification is performed to form the gasification product. A liquid sorbent composition is sprayed to the gasification product, and the gasification product is cooled. The gasification product is supplied at a temperature of below 500° C. to a filter in which solids comprising chloride is removed from the gasification product. Chlorine, such as chloride compounds, e.g. HCl, can be removed from the gasification product by spraying the sorbent composition to the gas before the gas is filtered. Simultaneously, when the sorbent composition is sprayed, the gasification product may be cooled.

An apparatus for cleaning a gasification product formed from plastic-based raw material by means of a gasification comprises at least a gasification unit for forming a gasification product. The gasification unit comprising at least one fluidized bed gasification reactor for gasifying the plastic-based raw material containing chlorine and for forming the gasification product. Further, the apparatus comprises at least one means for spraying a liquid sorbent composition to the gasification product, and optionally at least one cooling device for cooling the gasification product. In one embodiment, the apparatus can comprise at least one means for spraying, or alternatively at least one means for spraying and at least one cooling device, or alternatively at least one cooling device and at least one means for spraying. Preferably, the gasification product is also cooled in spraying and using the means for spraying. Further, the apparatus comprises at least one filter and at least one means for supplying the gasification product at a temperature of below 500° C. to the filter in which solids comprising chloride is removed from the gasification product.

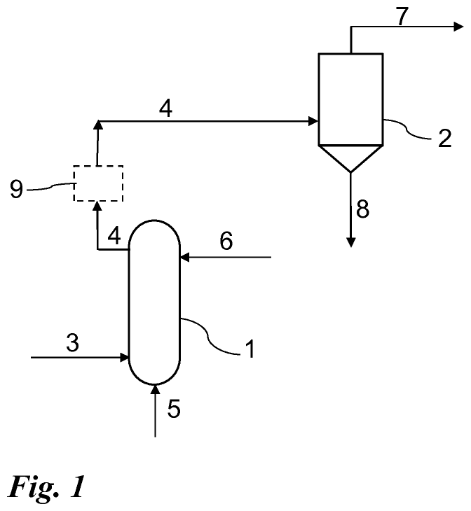

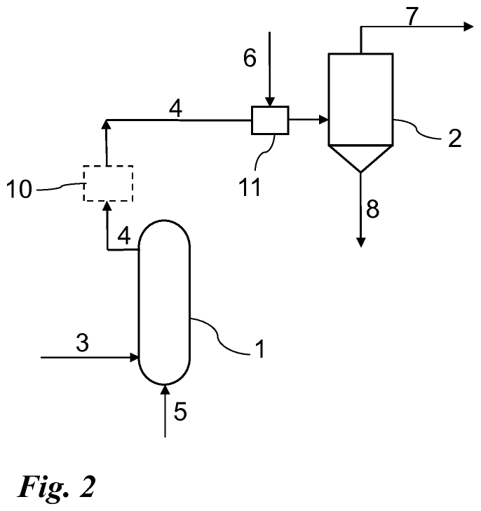

Some embodiments of the method and the apparatus are shown in FIGS. 1 and 2.

In this context, the gasification in the gasification unit means any gasification process, e.g. by steam. The gasification is a process that converts raw material into products, such as gasification products, for example plastic-based raw material can be chemically recycled back to virgin-like olefins. This is achieved by treating the raw material at suitable temperatures, and optionally with a controlled amount of steam. In one embodiment, the gasification is carried out at 680-750° C. Any suitable gasification reactor or gasifier may be used as the gasification reactor in the gasification unit. In one embodiment, the fluidized bed gasification reactor is selected from a bubbling fluidized bed (BFB) gasifier or a circulating fluidized bed (CFB) gasifier. In one embodiment, the gasification is carried out with steam. In one embodiment, the residence time may be below 10 seconds, in one embodiment 0.5-10 seconds, or in one embodiment 0.7-8 seconds, in the gasification reactor.

In this context, the plastic-based raw material means any plastic-based mixture, plastic mixture, waste material comprising plastic, plastic-based waste or the like, and the plastic-based raw material may comprise one or more components. The plastic-based raw material comprises at least some plastic component, e.g. one or more polymers. The plastic-based raw material comprises at least 30 % by weight plastic, in one embodiment at least 50 % by weight plastic. In one embodiment, the plastic-based raw material mainly consists of plastic. In one embodiment, the plastic-based raw material may be plastic waste or collected plastics waste. In one embodiment, the plastic-based raw material may comprise recycled plastics. The plastic-based raw material may comprise polyolefins, e.g. polyethylene or polypropylene, and other polymers, and further other components, such as paper, cardboard and/or aluminium material. Further, in this context, the plastic-based raw material contains chlorine, e.g. as an impurity. In this context, chlorine may be in the form of chlorine, chloride, chloride compound or the like. In one embodiment, chlorine is in a solid form. In one embodiment, the plastic-based raw material comprises chlorine below 5 w-%, or below 3 w-%, or below 2 w-%. In one embodiment, the plastic-based raw material comprises chlorine 0.1-4 w-%, or 0.5-3 w-%. In one embodiment, the plastic-based raw material comprises PVC plastic. In one embodiment, the plastic-based raw material comprises at least one halogen, e.g. as an impurity. In one embodiment, the plastic-based raw material may comprise also Al. The gasification product is formed from the plastic-based raw material in the gasification unit.

In this context, the gasification product means any product, flow, gas or the like, formed in the gasification unit. In one embodiment, the gasification product is gaseous product, such as gas. The gasification product comprises at least some olefins, e.g. ethylene and propylene, and the gasification product may be rich in olefins. Further, the gasification product may comprise aromatics, e.g. benzene and toluene, and other hydrocarbons, e. g. butadiene. Usually, the gasification product is a mixture of hydrocarbons. Further, the gasification product comprises chlorine, such as chloride or chloride compound when the plastic-based raw material contains chlorine. In one embodiment, the gasification product comprises HCl. In one embodiment, the plastic-based raw material contains PVC, and PCV converts into HCl in the gasification reactor.

In one embodiment, at least one cooling device is used to cool the gasification product. In one embodiment, the cooling device is a water quench device or a heat exchanger. In one embodiment, the apparatus comprises at least one cooling device, e.g. a water quench or heat exchanger, in the gasification unit for cooling the gasification product.

The sorbent composition is sprayed to the gasification product, e.g. in order to form a treated gasification product. When the sorbent composition is added by spraying to the gasification product, dispersion of the sorbent can be improved. Then chlorine removal efficiency may be enhanced. In this context, the sorbent composition means any liquid sorbent composition, liquid sorbent mixture, slurry sorbent composition, slurry sorbent mixture or the like, in which the sorbent composition comprise at least one or more sorbent components and liquid. In one embodiment, the sorbent composition is an aqueous sorbent composition. Alternatively, the sorbent composition may comprises any suitable liquid. The sorbent composition comprises at least one sorbent or sorbent compound. In one embodiment, the sorbent composition is an alkaline sorbent composition. In one embodiment, the sorbent composition comprises CaOH and/or NaHCO₃. Alternatively, the sorbent composition comprises another suitable sorbent compound or compounds. For example, HCl is very reactive with alkaline sorbents. In one embodiment, the sorbent composition is sprayed to the gasification product as a slurry. Dispersion of the sorbent can be enhanced by spraying the sorbent composition as a slurry. In one embodiment, the sorbent composition is a water slurry which is fed as a spray to the gasification product. In one embodiment, the sorbent composition is a water slurry including water and CaOH and/or NaHCO₃. When the sorbent composition is sprayed to the gasification product, the gasification product can be simultaneously cooled, and thus further cooling, e.g. first cooling step after the gasification, can be reduced to achieve temperature of less than 500° C. in the gasification product before the filter.

In one embodiment, the sorbent composition is sprayed in a top part of the gasification reactor. In one embodiment, the gasification product is cooled by spraying the sorbent composition for slowing and/or stopping the chemical reactions after the gasification in the top part of the gasification reactor. Then spraying and cooling are performed simultaneously when the sorbent composition is sprayed. In one embodiment, the gasification product is further cooled by means of a cooling device after the gasification reactor. In one embodiment, the gasification product is cooled using a water quench device after the gasification reactor. In one embodiment, the gasification product is cooled using a heat exchanger after the gasification reactor. Preferably, the heat exchanger is an empty pass heat exchanger. The empty pass heat exchanger means the heat exchanger which does not comprise an inner structure and which has an empty space inside the heat exchanger. In the empty pass heat exchanger heat transfer takes place on inside walls of the heat exchanger. Then the fouling of the heat exchanger can be avoided, e.g. by tars or sticky components, and thus the heat exchanger does not clogged up.

In one embodiment, the means for spraying the sorbent composition to the gasification product is arranged in a top part of the gasification reactor in which the top part is an upper quarter of the gasification reactor. Preferably, the upper quarter of the gasification reactor is a quarter from the top end of the gasification reactor. In one embodiment, the apparatus comprises at least one cooling device, e.g. a water quench device or heat exchanger, e.g. an empty pass heat exchanger, for cooling the gasification product before the filter. In one embodiment, the means for spraying the sorbent composition comprises a spraying apparatus, or alternatively any suitable device for spraying a liquid sorbent composition or a slurry sorbent composition.

In one embodiment, the plastic-based raw material comprises aluminium, and the sorbent composition is sprayed in a top part of the gasification reactor. In one embodiment, the gasification is carried out in a bubbling fluidized bed gasification reactor.

In one embodiment, the plastic-based raw material comprises aluminium, and the sorbent composition is sprayed in a top part of the bubbling fluidized bed gasification reactor. the gasification product is cooled by spraying the sorbent composition for slowing and/or stopping the chemical reactions after the gasification in the top part of the gasification reactor. In one embodiment, further cooling may be carried out after the gasification reactor by cooling the gasification product by means of a cooling device, e.g. using a water quench device or heat exchanger, e. g. an empty pass heat exchanger. In one embodiment, the gasification product is cooled by spraying the sorbent composition to temperature of less than 670° C. Then aluminium may be solidified. In one embodiment, the gasification product is further cooled using a cooling device to temperature of below 500° C. before the filter.

In one embodiment, the sorbent composition is sprayed between the gasification reactor and the filter. In one embodiment, the gasification product is cooled by spraying the sorbent composition, e.g. for slowing and/or stopping the chemical reactions after the gasification. In one embodiment, the gasification product is further cooled by means of a cooling device, e.g. using a water quench or heat exchanger, e. g. an empty pass heat exchanger, after spraying. In one embodiment, the gasification product is cooled by means of a cooling device, and the sorbent composition is sprayed to the gasification product. Then cooling with the cooling device can be performed for slowing and/or stopping the chemical reactions after the gasification, and after that the sorbent composition is sprayed to the gasification product.

In one embodiment, the means for spraying the sorbent composition to the gasification product is arranged between the gasification reactor and the filter. In one embodiment, the apparatus comprises at least one cooling device, arranged before the means for spraying the sorbent composition, for cooling the gasification product before spraying the sorbent composition. In one embodiment, the apparatus comprises at least one water quench device or heat exchanger as the cooling device. In one embodiment, the apparatus comprises at least one cooling device, e.g. a water quench or heat exchanger, e.g. an empty pass heat exchanger, arranged after the means for spraying the sorbent composition, for cooling the gasification product after spraying the sorbent composition. In one embodiment, the means for spraying the sorbent composition comprises a spraying apparatus, or alternatively any suitable device for spraying a liquid sorbent composition or a slurry sorbent composition. Further, in one embodiment, the means for spraying the sorbent composition comprises a spray chamber or an extended pipe or pipe part, e.g. in connection with means for supplying the gasification product to the filter, in which spraying is performed.

In one embodiment, the sorbent composition is sprayed between the gasification reactor and the filter, and the gasification product is cooled by spraying the sorbent composition for slowing and/or stopping the chemical reactions after the gasification. In one embodiment, the gasification product is further cooled by means of a cooling device after spraying. In one embodiment, the gasification product is cooled by means of a cooling device, e.g. using a water quench or heat exchanger, after the gasification reactor, e.g. for slowing and/or stopping the chemical reactions, and after that the sorbent composition is sprayed to the gasification product. In one embodiment, the gasification product is cooled to temperature of less than 500° C. before the filter.

The apparatus comprises at least one means for supplying the gasification product to the filter. Any suitable means, equipments and devices can be used as the means for supplying the gasification product to the filter. In one embodiment, the means comprise a pipe, pipes, pipeline, gas channel or the like or their combinations. In one embodiment, the means comprise at least one pipe. In one embodiment, the means for spraying the sorbent composition is arranged in connection with means for supplying the gasification product to the filter.

The gasification product is filtered after the gasification reactor, especially after spraying the sorbent composition to the gasification product and cooling the gasification product to temperature of below 500° C. Chlorine, such as chloride or chloride compounds, e.g. HCl, can be removed from the gasification product in connection with the filter. Sorbents of the sorbent composition react with chlorine compound, e.g. HCl, for forming solid chloride, which is removed together with other solids from the gasification product by using the filter. In one embodiment, at least some halide or halide compounds can be removed from the gasification product in connection with the filter. In one embodiment, chlorine, such as chloride or chloride compound, and optionally halide or halide compound, reacts with the sorbent primarily inside a filter dust cake, i.e. a reaction takes place in the filter dust cake. In one embodiment, HCl reacts very efficiently with the sorbent primarily inside a filter dust cake, and a reaction product is solid, and chlorides are removed from the gasification product together with other solids. Any suitable filter or filtration device may be used as the filter.

In one embodiment, the plastic-based raw material comprises halogen, and the halide is removed from the gasification product in the filter. Then a suitable sorbent composition may be used for removing the halide.

When the sorbent composition is added to the gasification product before the filter, the dispersion of the sorbent can be improved in the gasification product. Further, the gasification product can be cooled by spraying the sorbent composition. In one embodiment, the chemical reactions can be stopped after the gasification simultaneously by cooling with the sorbent composition spray. Further, possible water can be vaporized before the filter. Thus, when the sorbent composition is added to the gasification product before the filter, effective chlorine removal can be achieved in the process. Further, aluminium can be solidified effectively.

Temperature of the gasification product is arranged to temperature of below 500° C., or below 490° C., before a filtration in the filter. In one embodiment, temperature is over 300° C., or over 350° C., before the filtration. In one embodiment, temperature of the gasification product is arranged to 300-500° C., or to 350-500° C., before the filtration. In one embodiment, temperature of the gasification product is arranged to 380-500 C, or to 400-500° C., or to 410-490° C., before the filtration in the filter. When the temperature is below 500° C., or below 490° C., in the filter, efficiency of the filtration can be improved. For example, if the gasification product contains alkali metals, the alkali metals do not vaporize at temperature of below 500° C. and then the alkali metals can be recovered in the filter. Further, coke forms easily at temperatures of over 500° C. If temperature is over 500° C., solid coke may begin to form and the formed coke may clog the filter, and in order to minimize risk of clogging the filter it is important that the temperature is limited below 500° C.

The gasification product is cooled after the gasification in order to slow and/or stop chemical reactions. In one embodiment, the gasification product is cooled rapidly to temperature which is below 640° C. or below 610° C. after the gasification in order to slow and/or stop chemical reactions. In one embodiment, reactions are killed rapidly after the gasification by cooling the gasification product to temperature of below 600° C., in one embodiment below 550° C., in order to slow and/or stop chemical reactions. The chemical reactions can be slowed and/or stopped by cooling rapidly after the gasification, by spraying the sorbent composition and/or by cooling using a cooling device. In one embodiment, the stopping of the chemical reactions is performed during a time period of less than 2 seconds from the gasification. In one embodiment, the stopping of the chemical reactions is performed in the top part of the gasification reactor.

In one embodiment, the gasification product is cooled by spraying the sorbent composition to temperature of less than 670° C. in the top part of the gasification reactor. In one embodiment, the gasification product is cooled by spraying the sorbent composition to temperature of below 670° C. in the top part of the gasification reactor, and after that further cooled using a cooling device to temperature of below 500° C., or to 380-500° C., or to 400-500° C., or to 410-490° C., before the filter. In one embodiment, the chemical reactions after the gasification can be slowed and/or stopped by spraying the sorbent composition to the gasification product in the top part of the gasification reactor.

In one embodiment, the gasification product is cooled by spraying the sorbent composition, and optionally using cooling device after spraying, to temperature of less than 500° C., or to 380-500° C., or to 400-500° C., or to 410 490° C., before the filter. In one embodiment, the gasification product is cooled using a cooling device and after that further cooled by spraying the sorbent composition to temperature of below 500° C., or to 380-500° C., or to 400-500° C., or to 410-490° C. In one embodiment, the gasification product is cooled to temperature of below 700° C., in one embodiment to temperature of 600-700° C., rapidly after the gasification, e.g. using a cooling device, and after that further cooled by spraying the sorbent composition to temperature of below 500° C., or to 380-500° C., or to 400-500° C., or to 410-490° C. In one embodiment, the chemical reactions after the gasification can be slowed and/or stopped by cooling the gasification product rapidly after the gasification. In one embodiment, the chemical reactions after the gasification can be slowed and/or stopped by spraying the sorbent composition to the gasification product, e.g. rapidly after the gasification reactor. In one embodiment, the chemical reactions after the gasification can be slowed and/or stopped by cooling the gasification product using a cooling device.

In one embodiment, the apparatus, such as the gasification and the gasification unit, is a part of an integrated process. In the integrated process, the gasification unit comprising the gasification reactor is interconnected to the steam cracking unit, e.g. an olefin cracking unit. The integrated process comprises at least one gasification unit for forming a gasification product, at least one steam cracking unit for forming a cracking product and at least one recovery unit for recovering hydrocarbons. Usually, the steam cracking unit comprises at least one cracking furnace, at least one quench column and at least one transfer line for supplying a feed to next process step. Further, the steam cracking unit may comprise at least one cooling device to cool the cracking product before the quench column or a main quench tower. Typically, the recovery unit may comprise a main quench tower. In the recovery unit, the feed can be fractionated in a fractionation section. The gasification product and the cracking product are supplied to the recovery unit for separating and recovering desired hydrocarbons or to the main quench tower of the recovery unit. The desired hydrocarbons may comprise different hydrocarbons and one or more hydrocarbon fractions. In one embodiment, the gasification product and the cracking product are combined before the recovery unit to form the feed to the recovery unit.

The method and apparatus are based on a continuous process.

In one embodiment, the method and apparatus can be used in a production of olefins, aromatics, e.g. benzene, toluene or other aromatics, other hydrocarbons, polymers, polyolefins or the like, in a production of synthesis gas, in a production of products from recycled plastic waste, in a recycling of polyolefins back to light olefins, or their combinations.

Thanks to the invention, chlorine, chloride and chloride compounds can be removed effectively from plastic-based raw material. Further, other halides can be removed from plastic-based raw material. Plastic-based raw material, e.g. plastic waste, which comprises chlorine, chlorine compounds or PVC, can be used as a feed to the gasification or to processes comprising gasification or to processes where olefins are formed from the plastic-based raw material. Further, the feed of the process has not to be cleaned as efficiently as without the present chlorine removal. Then selection of potential feeds widens significantly.

The method and apparatus offer a possibility to treat plastic-based raw material and to produce different products e.g. olefins or synthesis gas, easily and energy- and cost-effectively. The present invention provides an industrially applicable, simple and affordable way to produce desired products from different plastic-based raw materials. The method and apparatus are easy and simple to realize in connection with production processes.

Further, the recycling of plastics can be improved by means of the invention. Recycled materials can be treated and utilized easily and effectively.

### EXAMPLES

FIGS. 1 and 2 present some embodiments of the process for cleaning a gasification product, i.e. a gasification gas, formed from plastic-based raw material by means of a gasification.

In FIG. 1, the apparatus comprises at least a gasification unit for forming a gasification product. The gasification unit comprising a fluidized bed gasification reactor (1), which is a bubbling fluidized bed reactor, for gasifying the plastic-based raw material (3) containing chlorine, e.g. PVC, and also aluminium. The gasification is carried out with steam (5) to form the gasification product (4). The steam is supplied to a bottom of the gasification reactor. The gasification product comprises chlorine compound, e.g. HCl, and aluminium. Further, the apparatus comprises means for spraying a liquid sorbent composition (6), e.g. a liquid alkaline sorbent composition, to the gasification product. The means for spraying the liquid sorbent composition can be a spraying apparatus or another suitable device for spraying. The liquid sorbent composition is sprayed in a top part of the bubbling fluidized bed gasification reactor. The top part is an upper quarter of the gasification reactor, and the upper quarter of the gasification reactor is a quarter from the top end of the gasification reactor. The gasification product is also cooled when the sorbent composition is sprayed in the top part of the gasification reactor. Then the chemical reactions can be slowed and/or stopped after the gasification. The gasification product can be cooled by spraying the sorbent composition to temperature of less than 670° C., or to temperature of less than 640° C. or in preferable embodiment less than 600° C., or directly to temperature of less than 500° C. Optionally the apparatus can comprise a cooling device (9), e.g. a water quench device, for cooling the gasification product after the gasification reactor. Further, the apparatus comprises a filter (2) and means for supplying the gasification product, e. g. pipeline, at a temperature of below 500° C. to the filter. The gasification product (4) is arranged to a temperature of below 500° C. before the filter. In the filter (2) solids (8) comprising chloride is removed from the gasification product to form a cleaned gasification product (7). The chlorine compound, e.g. HCl, reacts with the sorbent primarily inside a filter dust cake to form a solid reaction product. Chlorides are removed from the gasification product together with other solids.

The apparatus of FIG. 2 comprises at least a gasification unit for forming a gasification product. The gasification unit comprising a fluidized bed gasification reactor (1), which can be a circulating fluidized bed reactor or a bubbling fluidized bed reactor, for gasifying the plastic-based raw material (3) containing chlorine, e.g. PVC, with steam (5) to form the gasification product (4). The steam is supplied to a bottom of the gasification reactor. The gasification product comprises chlorine compound, e.g. HCl. Further, the apparatus comprises means (11) for spraying a liquid sorbent composition (6), e.g. a alkaline sorbent composition, as a slurry to the gasification product. For example, CaOH or NaHCO₃ may be used as a sorbent of the sorbent composition. The means for spraying the sorbent composition can be a spraying apparatus or another suitable device for spraying, which may comprise a spray chamber or an extended pipe or pipe part. Further, the apparatus comprises a filter (2). The sorbent composition is sprayed between the gasification reactor (1) and the filter (2). The gasification product can be also cooled simultaneously when the sorbent composition is sprayed. Further, the apparatus can comprise a cooling device (10), e.g. a water quench device or a heat exchanger, for cooling the gasification product after the gasification reactor and before spraying the sorbent composition (6). Alternatively, the apparatus can comprise a cooling device, e. g. a water quench device, for cooling the gasification product after spraying the sorbent composition. The chemical reactions can be slowed and/or stopped after the gasification by cooling to temperature of less than 640° C., or in preferable embodiment less than 600° C., in the first cooling step, e.g. rapidly after the gasification, in the cooling device (10) or in the spraying (11). Further, the apparatus comprises means for supplying the gasification product, e.g. pipeline, at a temperature of below 500° C. to the filter. The means for spraying the sorbent composition can be placed in connection with means for supplying the gasification product to the filter. The gasification product (4) is arranged to a temperature of below 500° C. before the filter. The gasification product can be cooled by spraying the sorbent composition directly to temperature of less than 500° C. In an alternative embodiment, the gasification product may be first cooled by spraying the sorbent composition and after that cooled by the cooling device to temperature of less than 500° C. If the apparatus comprises the cooling device (10) after the gasification reactor, the gasification product can be first cooled by the cooling device (10) and after that cooled by spraying the sorbent composition to temperature of less than 500° C. In the filter (2) solids (8) comprising chloride is removed from the gasification product to form a cleaned gasification product (7). The chlorine compound, e.g. HCl, reacts with the sorbent primarily inside a filter dust cake to form a solid reaction product. Chlorides are removed from the gasification product together with other solids.

In one embodiment, the plastic-based raw material may comprise also other halogen, and then corresponding halide or halide compound may be removed from the gasification product together with the solids in the present processes.

When the sorbent is added by spraying, a dispersion of the sorbent can be enhanced. The better dispersion results in higher utilization rate of the sorbent, and thus higher chloride or halide removal efficiency and reduced residue of chlorine removal.

In one embodiment, the apparatus of FIG. 1 or 2 is a part of the integrated process, as presented previously in the description, comprising the gasification unit for forming the gasification product, a steam cracking unit for forming a cracking product and a recovery unit for recovering hydrocarbons.

In the tests, it was observed that chlorine can be removed effectively from the gas, formed in the gasification reactor, by spraying the sorbent to the gas and filtering the gas.

Any suitable devices and equipments can be used in the processes of these examples.

The method and apparatus are suitable in different embodiments for treating different plastic-based raw materials and for cleaning gasification products formed from different plastic-based raw materials.

The invention is not limited merely to the examples referred to above; instead many variations are possible within the scope of the inventive idea defined by the claims.

1. A method for cleaning a gasification product formed from plastic-based raw material by means of a gasification wherein the method comprises:
gasifying the plastic-based raw material containing chlorine in the gasification unit comprising at least one fluidized bed gasification reactor in which the gasification is performed to form the gasification product,
spraying a liquid sorbent composition to the gasification product, and cooling the gasification product, and
supplying the gasification product at a temperature of below 500° C. to a filter in which solids comprising chloride is removed from the gasification product.

2. The method according to claim 1, wherein the sorbent composition is sprayed in a top part of the gasification reactor.

3. The method according to claim 2, wherein the gasification product is cooled by spraying the sorbent composition for slowing and/or stopping chemical reactions after the gasification.

4. The method according to claim 2, wherein the gasification product is cooled by spraying the sorbent composition to temperature of less than 670° C. in the top part of the gasification reactor.

5. The method according to claim 2, wherein the gasification product is cooled by means of a cooling device after the gasification reactor.

6. The method according to claim 2, wherein the gasification product is cooled using a water quench device.

7. The method according to claim 2, wherein the plastic-based raw material comprises aluminium.

8. The method according to claim 2, wherein the gasification is carried out in a bubbling fluidized bed gasification reactor.

9. The method according to claim 1, wherein the sorbent composition is sprayed between the gasification reactor and the filter.

10. The method according to claim 9, wherein the gasification product is cooled by spraying the sorbent composition.

11. The method according to claim 9, wherein the gasification product is cooled by means of a cooling device after spraying the sorbent composition to the gasification product.

12. The method according to claim 9, wherein the gasification product is cooled by means of a cooling device, and the sorbent composition is sprayed to the gasification product.

13. The method according to claim 9, wherein the gasification product is cooled to temperature of less than 640° C. for slowing and/or stopping the chemical reactions after the gasification.

14. The method according to claim 1, wherein the sorbent composition is a water slurry which is fed as a spray to the gasification product.

15. The method according to claim 1, wherein the sorbent composition is an alkaline sorbent composition.

16. The method according to claim 1, wherein the sorbent composition comprises CaOH and/or NaHCO₃.

17. The method according to claim 1, wherein the gasification is carried out with steam.

18. The method according to claim 5, wherein the cooling device is a water quench device or a heat exchanger.

19. The method according to claim 1, wherein temperature of the gasification product is arranged to 300-500° C. before a filtration in the filter.

20. An apparatus for cleaning a gasification product formed from plastic-based raw material by means of a gasification, in which the apparatus comprises at least a gasification unit for forming a gasification product, wherein the apparatus comprises:
the gasification unit comprising at least one fluidized bed gasification reactor for gasifying the plastic-based raw material containing chlorine and for forming the gasification product,
at least one means for spraying a liquid sorbent composition to the gasification product, and optionally at least one cooling device for cooling the gasification product, and
at least one filter and at least one means for supplying the gasification product at a temperature of below 500° C. to the filter in which solids comprising chloride is removed from the gasification product.

21. The apparatus according to claim 20, wherein the means for spraying the sorbent composition to the gasification product is arranged in a top part of the gasification reactor in which the top part is an upper quarter of the gasification reactor.

22. The apparatus according to claim 20, wherein the apparatus comprises at least one cooling device for cooling the gasification product before the filter.

23. The apparatus according to claim 20, wherein the means for spraying the sorbent composition to the gasification product is arranged between the gasification reactor and the filter.

24. The apparatus according to claim 23, wherein the apparatus comprises at least one cooling device, arranged before the means for spraying the sorbent composition.

25. The apparatus according to claim 23, wherein the apparatus comprises at least one cooling device, arranged after the means for spraying the sorbent composition.

26. The apparatus according to claim 23, wherein the apparatus comprises at least one water quench device or heat exchanger as the cooling device.

27. The apparatus according to claim 23, wherein the fluidized bed gasification reactor is selected from a bubbling fluidized bed gasifier or a circulating fluidized bed gasifier.

28. (canceled)
